(19) United States
(12) Patent Application Publication
(10) Pub. No.: US 2012/0236010 A1
(43) Pub. Date: Sep. 20, 2012

(54) Page Fault Handling Mechanism

(76) Inventors: Boris Ginzburg, Haifa (IL); Esfir Natanzon, Haifa (IL); Ilya Osadchiy, Haifa (IL); Ronny Ronen, Haifa (IL); Eliezer Weissmann, Haifa (IL); Yoav Zach, Pardes Hana Karkur (IL); Robert L. Farrell, Granite Bay, CA (US)

(21) Appl. No.: 13/048,053

(22) Filed: Mar. 15, 2011

(51) Int. Cl. G06F 15/16

(52) U.S. Cl. 345/502

(57) ABSTRACT

Page faults arising in a graphics processing unit may be handled by an operating system running on the central processing unit. In some embodiments, this means that unpinned memory can be used for the graphics processing unit. Using unpinned memory in the graphics processing unit may expand the capabilities of the graphics processing unit in some cases.

### BACKGROUND

This relates generally to processing units to handle page faults that arise in specialized devices, such as graphics processing units.

A page fault is an interrupt that occurs when software attempts to read from or to write to a virtual memory location that is marked as “not present” or when a page permission attribute prohibits corresponding access. Virtual memory systems maintain such status information about every page in a virtual memory address space. These pages are mapped onto physical addresses or are “not present” in physical memory. For example, when a read or write is detected to an unmapped virtual address or when page access permissions are violated, the device “page walker” generates a page fault interrupt. The operating system (OS) page fault handler responds to this page fault by swapping in data from disk to system memory, or by allocating new page (“copy on write”) and updating the status information in page table.

In order to avoid the possibility of page faults in graphics processing units, graphics processing units are generally constrained to using pinned memory. This means that in the last case, the page which is in graphics processor use, is pre-allocated and cannot be swapped to disk or remapped to new location in system memory.

In conventional systems, separate page tables are used by the central processing unit and the graphics processing unit. The operating system manages the host page table used by the central processing unit and a graphics processing unit driver manages the page table used by the graphics processing unit. The graphics processing unit driver copies data from user space into the driver memory for processing on the graphics processing unit. Complex data structures must be repacked into an array when pointers are replaced by offsets. The overhead related to copying and repacking limits graphics processing unit applications where data is represented as arrays. Thus, graphics processing units may be of limited value in some applications, including those that involve complex data structures such as databases.

### BRIEF DESCRIPTION OF THE DRAWINGS

FIG. 1 is a schematic depiction of one embodiment of the present invention;

FIG. 2 is extended thread and memory model in accordance with one embodiment of the present invention;

FIG. 3 is a flow chart for page fault handling in accordance with one embodiment of the present invention; and

FIG. 4 is a system depiction for one embodiment.

### DETAILED DESCRIPTION

In some embodiments, graphics processing applications may use complex data structures, such as databases, by using a shared virtual memory model that does not require pinning of shared memory. Pinning of shared virtual memory reduces an operating system's ability to manage system memory. In some embodiments, unpinned shared virtual memory may be used on the graphics processing unit when there is no guarantee that the page used by the graphics processing unit is present in system memory.

The graphics processing unit driver propagates page faults on the graphics processing unit to a shadow thread on the host/central processing unit. The host then emulates the page faults as if they occurred on the central processing unit to trigger the operating system to resolve the fault for the benefit of the graphics processing unit.

While the term graphics processing unit is used in the present application, it should be understood that the graphics processing unit may or may not be a separate integrated circuit. The present invention is applicable to situations where the graphics processing unit and the central processing unit are integrated into one integrated circuit.

In addition, while an example relating to graphics processing is given herein, in other embodiments, the same page fault handling techniques may be used in other specialized processing units, such as video processing, cards and input/output devices. In general, the page fault handling techniques may be used with any device that may experience page faults and which is accompanied by a processor that may act as a proxy to resolve those page faults. As used herein, a processor or processing unit may be a processor, controller, or coprocessor.

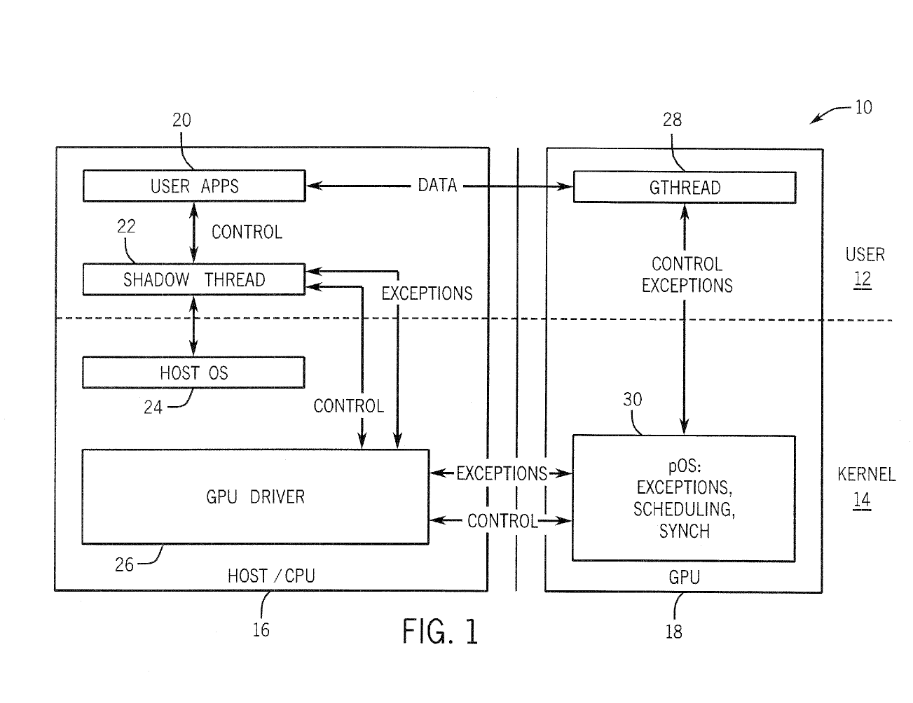

Referring to FIG. 1, a host/central processing unit 16 communicates with the graphics processing unit 18. The host central processing unit 16 includes user applications 20 which provide control information to a shadow thread 22. The shadow thread 22 then communicates exceptions and control information to the graphics processing unit driver 26. A shadow thread also communicates with the host operating system 24.

As shown in FIG. 1, the user level 12 includes a shadow thread 22 and the user applications 20, while the kernel level 14 includes a host operating system 24, and the graphics processing unit driver 26. The graphics processing unit driver 26 is a driver for the graphics processing unit even though that driver is resident in the central processing unit 16.

The graphics processing unit 18 includes, in user level 12, the gthread 28 which sends and receives control and exceptions messages to the operating system 30. A gthread is user code that runs on the graphics processing unit, sharing virtual memory with the parent thread running on the central processing unit. The operating system 30 may be a relatively small operating system, running on the graphics processing unit, that is responsible for graphics processing unit exceptions. It is a small relative to the host operating system 24, as one example.

User applications 20 are any user process that runs on the central processing unit 16. The user applications 20 spawn threads on the graphics processing unit 18.

An eXtended Threaded Library or XTL is an extension to create and manage user threads on the graphics processing unit. This library creates the shadow thread for each gthread.

User applications offload computations to the graphics processing unit using an extension of a traditional multithreaded model such as:
xthread_create (thread, attr, gpu_worker,arg).

The gthread or worker thread created on the graphics processing unit shares virtual memory with the parent thread. It behaves in the same way as a regular thread in that all standard inter-process synchronization mechanisms, such as Mutex and semaphore, can be used. At the same time, a new shadow thread is created on the host central processing unit 16. This shadow thread works as a proxy for exception handling units and synchronization between threads on the central processing unit and the graphics processing unit.

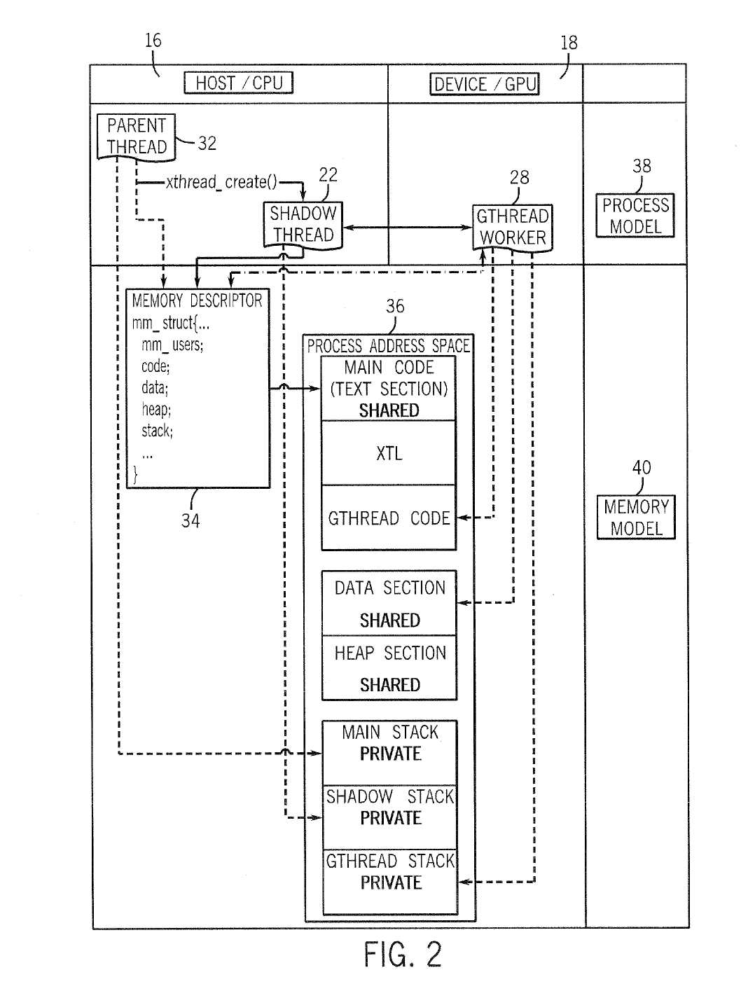

In some embodiments, the parent thread, the host shadow thread and the graphics processing unit worker threads may share unpinned virtual memory as shown in FIG. 2. Host/central processing unit 16 includes the parent thread 32 that generates the xthread_create( ) for the shadow thread 22. The shadow thread 22 accesses the shadow stack which is a private address space in the process address space 36. The parent thread 32 also accesses the memory descriptors 34 and the main stack, which is a private address space within the process address space 36. The memory descriptors 34 may also communicate with the gthread worker 28. The gthread worker 28 can access the gthread code within the process space 36 as well as the shared data section and the private gthread stack. The material in the upper blocks corresponds to the process model 38 and the lower blocks correspond to the memory model 40.

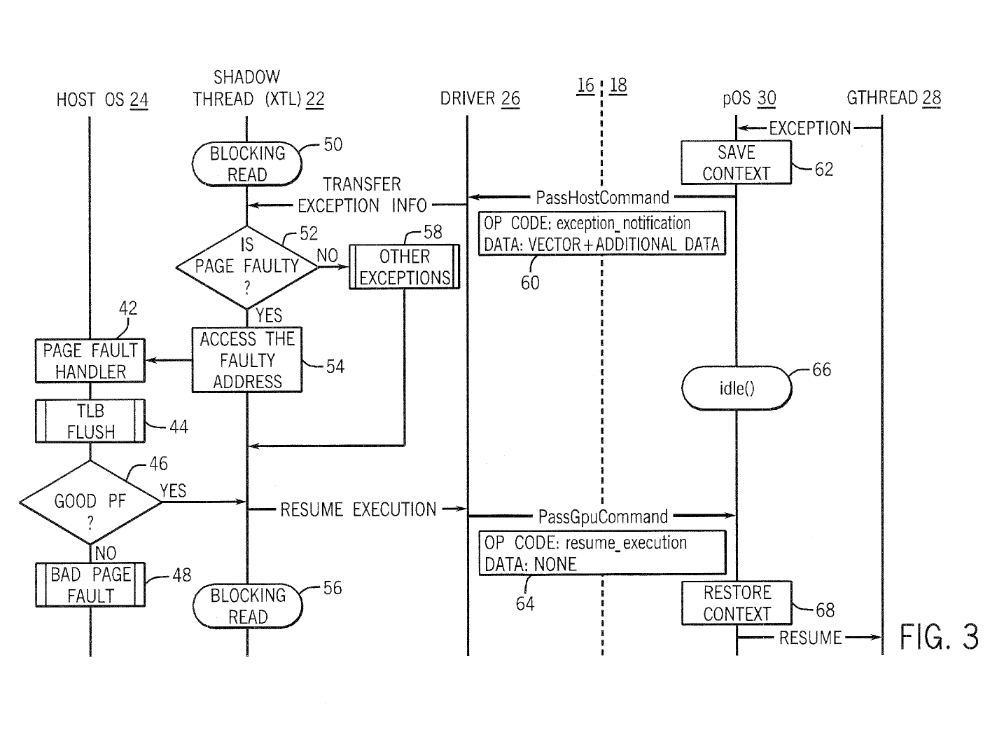

Referring to FIG. 3, the page fault handling algorithms may be implemented in hardware, software and/or firmware. In software embodiments, the algorithms may be implemented as computer executable instructions stored on a non-transitory computer readable medium such as an optical, semiconductor or magnetic memory. In FIG. 3, the flows for the host operating system 24, the shadow thread 22, driver 26 of the central processing unit 16, and the operating system 30, gthread 28 in the graphics processing unit 18 are shown as parallel vertical flow paths with interactions between them indicated by a generally horizontal arrows.

The graphics processing unit operating system 30 initially receives a page fault as indicated by the word “exception” and the corresponding arrow in FIG. 3, from the gthread 28. The operating system 30 saves the context (block 62) and sends a message 60 with the page fault information to the driver 26. The message may include an opcode “exception_notification” and data including the vector and additional information. Then the operating system 30 marks the thread as idle( ) as indicated in block 66, so the thread is considered “not ready, waiting for page fault resolution” and switches to another thread. The driver 26 wakes up the shadow thread 22 and transfers the page fault data to the shadow thread as indicated by the arrow labeled “transfer exception info.”

At 50, the shadow thread performs a blocking read to stop other activities until the page fault is resolved. Then the shadow thread 22 receives the page fault data. After checking to see if the page is faulty (diamond 52), the shadow thread reproduces the same access to the faulty address, as indicated a block 54, if the page is faulty. If the page is not faulty, the flow goes to block 58 to check for other exceptions, bypassing block 54. Then the block read is released at 56.

The host operating system 24 handles the page fault in the page fault handler 42. Effectively, the host operating system is tricked into handling the exception for the graphics processing unit. Then the translation lookaside buffer (TLB) may be flushed at 44. A check at diamond 46 determines if the page fault is good, i.e. fixed, in which case it advises the shadow thread 22. Otherwise, a bad page fault is indicated at 48, which may, for example, result in an error.

The shadow thread 22 sends the page fault resolved message (i.e. RESUME EXECUTION) to the driver 26. Then the shadow thread goes to a sleep state waiting for the next message from the driver using another blocking read 56.

The driver 26 receives the resume execution message from the shadow thread and sends a PassGPUCommand to the operating system 30 as indicated by the block 64. The message may include the opcode to resume execution with no data. The operating system 30 marks the thread as ready for execution, as indicated at 68, and returns from the exception by sending a resume message to the gthread 28.

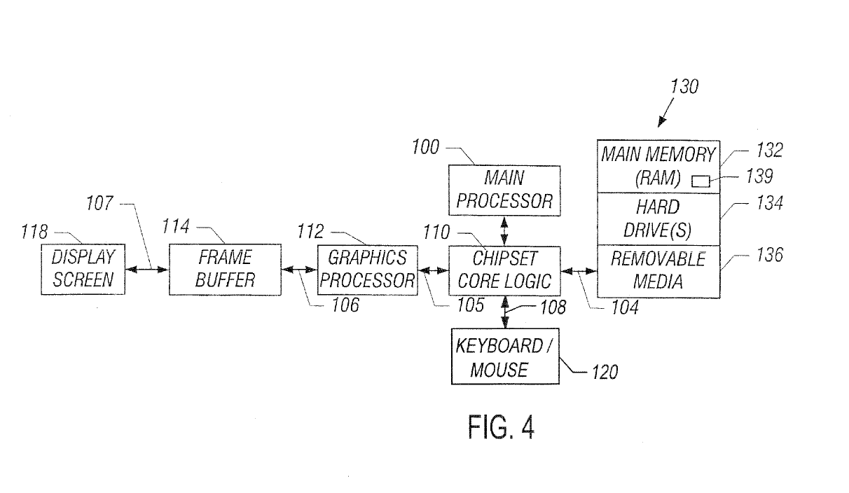

The computer system 130, shown in FIG. 4, may include a hard drive 134 and a removable medium 136, coupled by a bus 104 to a chipset core logic 110. A keyboard and mouse 120, or other conventional components, may be coupled to the chipset core logic via bus 108. The core logic may couple to the graphics processor 112, via a bus 105, and the central processor 100 in one embodiment. The graphics processor 112 may also be coupled by a bus 106 to a frame buffer 114. The frame buffer 114 may be coupled by a bus 107 to a display screen 118. In one embodiment, a graphics processor 112 may be a multi-threaded, multi-core parallel processor using single instruction multiple data (SIMD) architecture.

In the case of a software implementation, the pertinent code may be stored in any suitable semiconductor, magnetic, or optical memory, including the main memory 132 (as indicated at 139) or any available memory within the graphics processor. Thus, in one embodiment, the code to perform the sequences of FIG. 3 may be stored in a non-transitory machine or computer readable medium, such as the memory 132, and/or the graphics processor 112, and/or the central processor 100 and may be executed by the processor 100 and/or the graphics processor 112 in one embodiment.

FIG. 3 is a flow chart. In some embodiments, the sequences depicted in this flow chart may be implemented in hardware, software, or firmware. In a software embodiment, a non-transitory computer readable medium, such as a semiconductor memory, a magnetic memory, or an optical memory may be used to store instructions and may be executed by a processor to implement the sequences shown in FIG. 3.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
handling page faults, arising in a first processing unit, by an operating system running on a second processing unit.

2. The method of claim 1 including handling page faults arising in a graphics processing unit using an operating system running on a central processing unit.

3. The method of claim 2 including using a thread running on the central processing unit to reproduce and handle a page fault on the graphics processing unit.

4. The method of claim 2 including using a graphics processing unit operating system to pass a page fault to a driver on the central processing unit.

5. The method of claim 1 including using unpinned shared virtual memory.

6. The method of claim 5 including sharing said unpinned virtual memory between the first and second processing units.

7. A non-transitory computer readable medium storing instructions to enable a first processor to:
handle page faults, arising in a second processor, using an operating system running on said first processor.

8. The medium of claim 7 further storing instructions to handle page faults arising in a graphics processing unit using an operating system running on a central processing unit.

9. The medium of claim 8 further storing instructions to use a thread running on the central processing unit to reproduce and handle a page fault on the graphics processing unit.

10. The medium of claim 8 further storing instructions to use a graphics processing unit operating system to pass a page fault to a driver on the central processing unit.

11. The medium of claim 7 further storing instructions to use unpinned shared virtual memory.

12. The medium of claim 11 further storing instructions to share said unpinned virtual memory between said processors.

13. An apparatus comprising:
a processor to handle page faults arising on another processor; and
a memory coupled to said processor.

14. The apparatus of claim 13 wherein said processor is a central processing unit.

15. The apparatus of claim 13 including another processor which incurs page faults and which transfers said page faults to said processor for handling.

16. The apparatus of claim 13 wherein said another processor is a graphics processing unit.

17. The apparatus of claim 13 wherein said processor uses a thread to reproduce and handle a page fault on said another processor.

18. The apparatus of claim 13 including said processor and said another processor, wherein said another processor to pass a page fault to a driver on said central processing unit.

19. The apparatus of claim 15 wherein said another processor to use unpinned shared virtual memory.

20. The apparatus of claim 20 wherein said processor and said another processor share said unpinned virtual memory.
